(19) United States
(12) Patent Application Publication
(10) Pub. No.: US 2017/0360243 A1
(43) Pub. Date: Dec. 21, 2017

(54) BEVERAGE DISPENSING SYSTEM AND METHOD

(71) Applicant: CROWNE COFFEE CO., LLC, Salt Lake City, UT (US)

(72) Inventor: Jesse W. CROWNE, Salt Lake City, UT (US)

(21) Appl. No.: 15/625,919

(22) Filed: Jun. 16, 2017

Related U.S. Application Data
(60) Provisional application No. 62/351,673, filed on Jun. 17, 2016.

(51) Int. Cl. A47J 31/44; A23F 5/26; A23L 2/54; A47J 31/41

(52) U.S. Cl. CPC A47J 31/4403; A47J 31/41; A23F 5/26; A23L 2/54; A23V 2002/00

(57) ABSTRACT

A system for dispensing a beverage includes a storage vessel configured to store the beverage, a flow meter fluidly coupled to the storage vessel and configured obtain flow measurements of the beverage from the storage vessel, a first fluid path comprising a valve fluidly coupled to the flow meter and to a faucet, and a second fluid path comprising a heater fluidly coupled to the flow meter and to a flow restrictor. The heater is operable between a first state and a second state. The heater is configured to increase a temperature of the beverage passing through the heater to a target temperature when the heater is in the first state and configured to not to increase the temperature of the beverage passing through the heater when the heater is in the second state.

### CROSS REFERENCE TO RELATED APPLICATIONS

This application claims benefit of U.S. Provisional Patent Application No. 62/351,673 filed Jun. 17, 2016, incorporated herein by reference in its entirety.

### TECHNICAL FIELD

The present disclosure relates to a beverage brewing and dispensing systems and methods for using the same. More specifically, the present disclosure relates to a beverage brewing system and method that includes introducing nitrogen into the beverage, and a method and system for heating the beverage immediately prior to serving the beverage.

### BACKGROUND

Beverages may be served from a tap system. The tap system may include a reservoir, which stores the beverage, and a tap. In operation, an operator may articulate the tap to control dispensing of the beverage from the beverage system. A beverage dispensed from a tap is generally cold or room temperature. Such a beverage is typically introduced with a gas that is agitated by the tapper, such that the texture and mouthfeel of the beverage is distinct when dispensed. In a particular example, beer is commonly dispensed from a tapper and the resulting foam head that forms when the beer is dispensed is resultant from the gas-infused beverage being agitated by a tapper system as it is poured. The same desirable texture and mouthfeel of beer can be achieved in coffee, as described in the present application.

To achieve a frothy, foam head in coffee, the coffee also be nitrogenated. It is thought that heating a nitrogenated beverage prevents the desireable foam head from lingering from any significant amount of time. Accordingly, there is a need for a hot, nitrogenated beverage that is brewed and dispensed in such a way that substantially maintains the foam head and mouthfeel of coffee dispensed through a tap system.

### SUMMARY

One embodiment of the present disclosure relates a system for dispensing a beverage. The system for dispensing a beverage includes a storage vessel configured to store the beverage, a flow meter fluidly coupled to the storage vessel and configured obtain flow measurements of the beverage from the storage vessel, a first fluid path comprising a valve fluidly coupled to the flow meter and to a faucet, and a second fluid path comprising a heater fluidly coupled to the flow meter and to a flow restrictor. The heater is operable between a first state and a second state. The heater is configured to increase a temperature of the beverage passing through the heater to a target temperature when the heater is in the first state and configured to not to increase the temperature of the beverage passing through the heater when the heater is in the second state.

Another embodiment of the present disclosure relates to a method of providing hot, nitrogenated coffee. The method includes pressurizing a vessel at a first temperature with nitrogen at a target steeping pressure, steeping the vessel for a steeping time at a first temperature, decreasing a temperature of the vessel to a chilled steeping temperature lower than the first temperature, steeping at the second temperature, rapidly decreasing a pressure of the vessel in such a manner as to cause nitrogen cavitation within the vessel, thereby producing a brew fluid, and connecting the vessel to a filter unit.

Yet another embodiment of the present disclosure relates to a mobile delivery system for delivering hot, nitrogenated coffee to a customer. The mobile delivery system includes an application accessible by a customer using an external mobile device and a beverage dispensing system. The beverage dispensing system includes a storage vessel configured to store brewed and nitrogenated coffee, a flow meter fluidically coupled to the storage vessel and configured to measure flow of the brewed and nitrogenated coffee from the storage vessel, a valve fluidically coupled to the flow meter and to a faucet, a heater fluidically coupled to the flow meter and to a flow restrictor, and a processing circuit configured to be communicable with the application. The customer may place an order for a coffee at the beverage dispensing system using the application. The processing circuit is configured to receive the order and transmit an order confirmation to the customer, the order confirmation including a location of the mobile delivery system and an expected order completion time.

In some applications, the beverage is coffee. In other applications, the beverage is brewed and nitrogenated coffee. In other applications, the beverage is hot brewed and nitrogenated coffee.

The invention is capable of other embodiments and of being carried out in various ways. Alternative exemplary embodiments relate to other features and combinations of features.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a flow diagram of a process for brewing coffee, according to an exemplary embodiment of the present disclosure;

FIG. 2 is a flow diagram of a beverage dispensing system, according to an exemplary embodiment of the present disclosure;

FIG. 3 is a perspective view of a beverage dispensing system in a first configuration, according to an exemplary embodiment of the present disclosure;

FIG. 4 is a perspective view of the beverage dispensing system shown in FIG. 3 in a second configuration, according to an exemplary embodiment of the present disclosure;

FIG. 5 is a detailed view of the beverage dispensing system shown in FIG. 3;

FIG. 6 is a perspective view of another beverage dispensing system, according to an exemplary embodiment of the present disclosure;

FIG. 7 is a perspective view of a mobile delivery system, according to an exemplary embodiment of the present disclosure; and

FIG. 8 is a perspective view of a mobile delivery system, according to an exemplary embodiment of the present disclosure.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

According to an exemplary embodiment, a brewing process includes grinding coffee beans, adding ground coffee beans to a brew vessel containing water, pressurizing the brew vessel with nitrogen, decreasing the temperature of the brew vessel, rapidly decreasing the pressure of the brew vessel, filtering coffee in a filter unit, rinsing the filter, introducing the coffee into a storage vessel, and nitrogenating the coffee in the storage vessel. Rapidly decreasing the pressure of the brew vessel facilitates nitrogen cavitation, a process that increases the quality of the texture and mouthfeel of the coffee, thereby increasing the desirability of the coffee. Once in the brew vessel, the coffee may be dispensed to customers as either a hot or cold beverage, or a mixture thereof.

The coffee is dispensed through a beverage dispensing system. The beverage dispensing system utilizes a flow meter, a valve, a heater, a flow restrictor, a processing circuit, and a control switch to produce the coffee desired by the customer. If hot coffee is desired, coffee flows through the heater. The beverage dispensing system also includes a faucet that is configured to agitate the nitrogen in the brewed and nitrogenated coffee. When a hot coffee is desired by the customer, the hot coffee develops a foam head when dispensed. The foam head attributed to the nitrogen provides a unique and desirable aspect to the hot coffee. It has been discovered by the inventor that when prepared according to some exemplary embodiments, the nitrogen is unexpectedly able to maintain the foam head for some time because of the relatively high concentration of nitrogen in the Earth's atmosphere.

In some applications, a customer may interact with the beverage dispensing system via an application on an external mobile device. For example, the customer may order a specific coffee on the application, and the application may transmit the order to the operator of the beverage dispensing system. Then, the operator may use the beverage dispensing system to prepare the order. Similarly, the operator may utilize an external mobile device to monitor various aspects of the beverage dispensing system such as the amount of brewed and nitrogenated coffee remaining in the brew vessel.

In some embodiments, the beverage dispensing system is part of a mobile delivery system. For example, the mobile delivery system may provide customers with two different blends of brewed and nitrogenated coffee (e.g., dark and light, etc.). Further, the mobile delivery system may provide customers with a mixture of different blends of brewed and nitrogenated coffee. The mobile delivery system may be used to deliver orders to customers or to place the beverage dispensing system at a desired location such as at a sporting event, concert, festival, or other event. The mobile delivery system may cooperate with a mobile application to receive orders from customers.

### Brewing Process

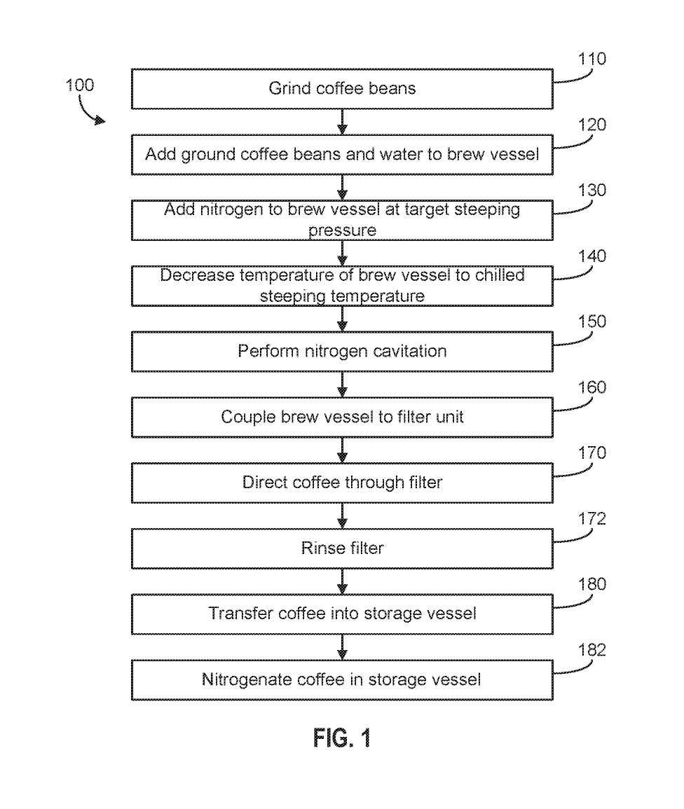

According to the exemplary embodiment of FIG. 1, brewing process 100 is described in detail. Brewing process 100 is used to transform coffee beans (e.g., coffee grounds, powder, mix, etc.) into brewed and nitrogenated coffee. Brewing process 100 begins with step 110, grinding the coffee beans to a target consistency (e.g., fine, coarse, etc.) using a grinder. In some embodiments, the coffee beans are coarsely ground using a commercial grinder. At step 120, the ground coffee beans are added to a first amount of water in a brew vessel. The brew vessel may be any vessel suitable to be pressurized, such as a keg (e.g.,

Sankey keg, Cornelius keg, etc.) or a conical fermenter. Typically, the brew vessel has a volume of between approximately 18.9 liters (e.g., 5 gallons) to 22.7 liters (e.g., 6 gallons).

At step 130, the brew vessel is pressurized to a target steeping pressure with nitrogen. Once the nitrogen has been added to the brew vessel, the brew vessel is allowed to steep at a first temperature. According to various embodiments, the first temperature is room temperature. At step 140, the temperature of the brew vessel is decreased to a chilled steeping temperature where the coffee continues to steep at a lower temperature than the first temperature. When the temperature of the brew vessel has been lowered in step 140, the solubility of the nitrogen in the brew vessel will increase. Similarly, the decrease in temperature that occurs in step 140 will cause different extraction of chemicals, thereby improving the flavor of the coffee.

Brewing process 100 includes a fifth step 150 where nitrogen cavitation is performed. At step 150, the pressure of the brew vessel is quickly reduced to atmospheric pressure (e.g., zero gauge pressure). This draws the gas in the coffee beans to come out of solution and releases additional flavor. At step 160, the brew vessel is connected (e.g., coupled) to a filter unit (i.e., with hoses, etc.). The filter unit is configured to filter the contents of the brew vessel. Brewing process 100 continues with seventh step 170, filtering the brewed coffee from the brew vessel through filters in the filter unit. At step 172, the filters are rinsed with a second amount of water. The brew vessel is then removed from the filter unit and the brewed coffee is poured or otherwise transferred into a storage vessel at step 180. Finally, at step 182 the storage vessel is loaded into (e.g., installed in, inserted in, etc.) a beverage dispensing system and the brewed coffee is nitrogenized at a target dispensing system pressure and is ready for dispensing.

Brewing process 100 may be defined as a cold brewing process. Brewing process 100 may produce a brewed and nitrogenated coffee that, by its particular process, has a greater amount of caffeine and is less bitter than conventional cold brew coffees. The target consistency of the coffee beans, as ground in step 110, may correspond to a target bitterness of the brewed and nitrogenated coffee. For example, finely ground coffee beans may result in a more bitter brewed and nitrogenated coffee than coarsely ground coffee beans. The water in step 120 and step 172 may be filtered water (i.e., through osmosis, etc.) or may contain a flavoring or additive. Similarly, different temperatures of the water in step 120 and step 172 may be used (e.g., hot, cold, boiling, etc.). In one example, approximately 15.1 liters (four gallons) of water is added in step 120 and approximately 5.7 liters (one and a half gallons) of water is used in step 172. In this example, brewing process 100 may produce approximately 18.1 liters (4.78 gallons) of brewed and nitrogenated coffee. Accordingly, it is understood that the amount of water added in step 120 and used in step 172 is related to the amount of brewed and nitrogenated coffee produced by brewing process 100.

Rather than, or in addition to, using nitrogen in step 130 and step 182, other gases such as nitrous oxide, other nitrogen-based gases, a noble gas, carbon dioxide, or other suitable gases may also be used such that brewing process 100 is tailored for a target application. In one example, nitrous oxide is used rather than nitrogen. For this example, the nitrous oxide may dissolve more efficiently, relative to the nitrogen, at a lower pressure. However, the nitrogen may be replaced with any of the aforementioned gases such that beverage dispensing system 200 may be tailored for a target application. It is understood that any of the forgoing gases may be used by beverage dispensing system 200 in a similar fashion to nitrogen. In one example, the target steeping pressure of the nitrogen in step 130 is approximately 268.9 kilopascals (kPa) (e.g., thirty-nine pounds per square inch (PSI)). However, other target steeping pressures of the nitrogen may be used in step 130 such as 186.2 kPa (e.g., 27 PSI), 241.3 kPa (e.g., 35 PSI), 268.9 kPa (e.g., 39 PSI), 310.3 kPa (e.g., 45 PSI), and other suitable pressures such that brewing process 100 is tailored for a target application. During step 130, cells and tissues of the ground coffee in the brew vessel are homogenized, thereby allowing the nitrogen to dissolve into the cells of the ground coffee.

At step 140, the chilled steeping temperature may be greater or lower than room temperature. In many applications, the chilled steeping temperature is lower than room temperature. According to an exemplary embodiment, the chilled steeping temperature is approximately 4.4 degrees Celsius (e.g., forty degrees Fahrenheit). However, other chilled steeping temperatures may similarly be used. The chilled steeping temperature may be chosen such that a difference (e.g., a temperature differential, a temperature gradient, etc.) between the chilled steeping temperature and the first temperature is tailored for a target application.

The nitrogen cavitation performed in step 150 is achieved by a sudden (e.g., near-instantaneous or instantaneous) decrease in pressure of the brew vessel. For example, a valve on the brew vessel may be opened thereby coupling the brew vessel to an external environment of a lower pressure (e.g., a room, a container, a vessel, etc.). During step 150, the cells of the ground coffee may receive nitrogen bubbles within the cells. As these bubbles break, the flavor compounds within the ground coffee may be released quickly, thereby allowing the flavor components to easily dissolve. Step 150 provides the final, brewed and nitrogenated coffee produced in step 182 with a target flavor. The length of time during which the pressure within the brew vessel is released in step 150 may be varied, controlled (e.g., according to a scheme or pattern), or otherwise modulated such that a target flavor of the brewed and nitrogenated coffee is achieved.

The filter unit used in step 160 may be configured to receive liquid from multiple brew vessels and to filter them simultaneously. The brew vessel may be coupled to the filter unit via a hose such that the brew vessel is coupled to a filter. In this manner, the filter unit may filter the contents of the brew vessel and then return the filtered contents to either the brew vessel or a storage vessel. The filter used in step 170 may be a variety of different filters suitable for filtering coffee grounds and other particulates from a brewed coffee. In one embodiment, the filter is a one micron Purenex™ filter. However, step 170 may utilize other sediment filters suitable for use in a reverse osmosis filtration system. The filter unit may be configured to receive multiple brew vessels at once. In one example, the filter unit is configured to receive six brew vessels. In another example, the filter unit is configured to receive ten brew vessels. The filter unit may use bag filters, cartridge filter, disk filters, and other similar filters. Similarly, filters having different filtration properties (e.g., different porosities, beta ratios, etc.) may also be used by the filter unit.

From the filter, coffee flows to the storage vessel. The beverage dispensing system may be various structures and devices configured to receive the storage vessel. For example, the beverage dispensing system may be a mobile cart, a bar, a cabinet, a refrigerator, a refrigerated compartment, a combination thereof, or any other suitable structure for beverage storage and dispensing. To install the storage vessel in the beverage dispensing system, the storages vessel may be connected to lines (e.g., pressurized lines, high pressure lines, hoses, tubes, etc.) from the beverage dispensing system. One of these lines leads directly to a faucet (e.g., stout faucet, tap, tapper, outlet, etc.) of the beverage dispensing system where a drinking or carrying receptacle may be filled with the brewed and nitrogenated coffee. Another of the lines leads directly to a pressurized tank (e.g., a bottle, canister, etc.).

The pressurized tank stores the nitrogen for use in step 182. According to various embodiments, the beverage dispensing system is refrigerated such that the storage vessel is refrigerated. Additionally, the beverage dispensing system may be insulated (e.g., thermally, acoustically, etc.) such that any thermal losses from within the storage vessel are minimized. During step 182, nitrogen exits the pressurized tank and is introduced to the storage vessel to pressurize the storage vessel to the target dispensing system pressure. In one embodiment, the target dispensing system pressure is approximately 310.3 kPa (e.g., 45 PSI). However, in other examples, the target dispensing system pressure may be other suitable pressures. In some applications, the target dispensing system pressure is a function of the storage vessel and/or the beverage dispensing system.

In various embodiments, the coffee is stored until dispensed from a faucet. The faucet may be a stout faucet including an agitator (e.g., restrictor plate). The agitator may be a device designed to limit the flow from the stout faucet such as a disk with a number of holes in it. When the brewed and nitrogenated coffee flows through the tiny holes in the agitator, the nitrogen comes out of solution and causes the brewed and nitrogenated coffee to foam. This effect may be referred to as a “cascade.” The stout faucet also includes a tap (e.g., handle) operable by an operator to dispense brewed and nitrogenated coffee. The tap may be a two position tap where each position corresponds to a different function such as pour and foam.

It is understood that brewing process 100 may include more or less steps depending on a target application and that the order of the aforementioned steps may be altered depending on the target application. For example, brewing process 100 may utilize pre-ground coffee beans thereby eliminating step 110 from brewing process 100. Similarly, additional steps may be added to brewing process 100. For example, an additive such as milk, cream, or flavoring may be added to the brewed coffee prior to dispensing. The following tables provide detailed insight into various non-limiting examples of brewing process 100.

| | | Amount | | Target | Duration | Chill | Filter | | Amount of | |
|---|---|---|---|---|---|---|---|---|---|---|
| | Fineness | of water | | steeping | of | time | pressure | | water used to | |
| | of ground | added in | | pressure in | steeping | in | in step | | rinse filter in | |
| | coffee | step 120 | | step 130 | time in | step | 170 [kPa | | step 172 | |
| | beans in | [liters | | [kPa (PSI)] | step 130 | 140 | (PSI)] | | [liters | |
| Example | step 110 | (gallons)] | | (gauge) | [hours] | [hours] | (gauge) | | (gallons)] | |
| 1 | Coarse | 75 | (19.8) | 310.3 (45) | 15 | 0.00 | 62.1 | (9) | 62.5 | (16.5) |
| 2 | Electric | 99.9 | (26.4) | 268.9 (39) | 15 | 0.00 | 34.5 | (5) | 37.5 | (9.9) |
| | percolator | | | | | | | | | |
| | grade | | | | | | | | | |
| 3 | Electric | 11.4 | (3) | 241.3 (35) | 11.5 | 3 | 62.1 | (9) | 9.5 | (2.5) |
| | percolator | | | | | | | | | |
| | grade | | | | | | | | | |
| 4 | Coarse | 15.1 | (4) | 268.9 (39) | 12 | 9.3 | 34.5 | (5) | 5.7 | (1.5) |
| 5 | Regular | 15.1 | (4) | 310.3 (45) | 14 | 2 | 55.2 | (8) | 0 | |
| | percolator | | | | | | | | | |
| | grade | | | | | | | | | |
| 6 | Regular | 15.1 | (4) | 310.3 (45) | 7 | 7.5 | 96.5 | (14) | 5.7 | (1.5) |
| | percolator | | | | | | | | | |
| | grade | | | | | | | | | |
| 7 | Auto- | 11.4 | (3) | 186.2 (27) | 9.5 | 3 | 62.1 | (9) | 9.5 | (2.5) |

drip

| | Amount of | Amount of | Amount of |
|---|---|---|---|
| | coffee | water | nitrogen |
| | [kilograms | [liters | [cubic meters |
| Example | (pounds)] | (gallons)] | (cubic feet)] |
| 1 | 9 (19.8) | 137.4 (36.3) | 0.13 (4.6) |
| 2 | 12 (26.4) | 137.4 (36.3) | 0.34 (12) |
| 3 | 1.4 (3) | 20.8 (5.5) | 0.02 (0.7) |
| 4 | 2 (4.4) | 20.8 (5.5) | 0.06 (2) |
| 5 | 2 (4.4) | 15.1 (4) | 0.02 (0.7) |
| 6 | 2 (4.4) | 20.8 (5.5) | 0.02 (0.7) |
| 7 | 1.4 (3) | 20.8 (5.5) | 0.02 (0.7) |

### Beverage Dispensing System

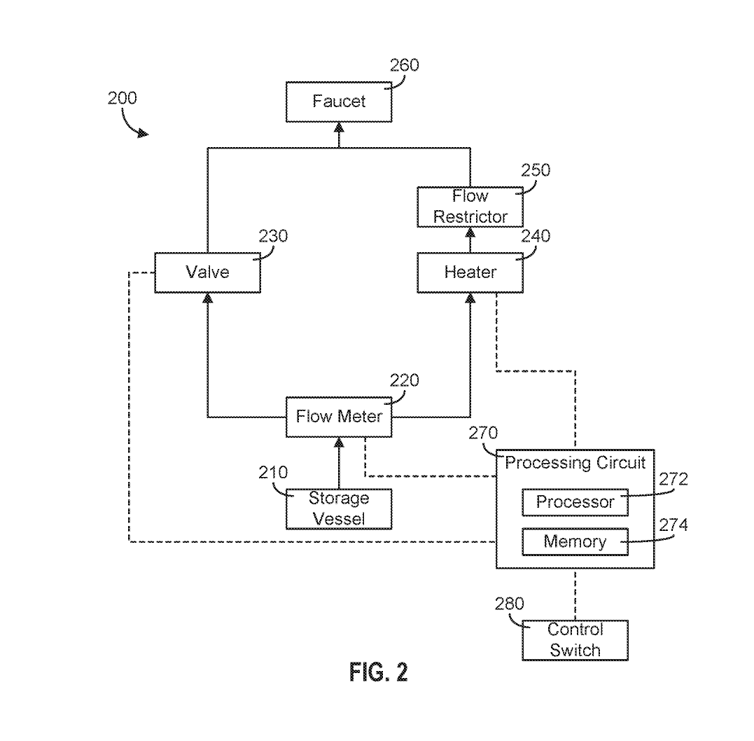

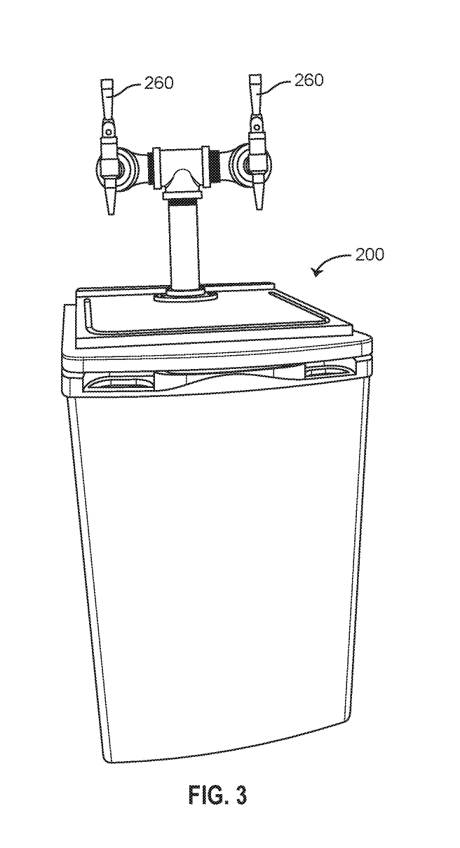

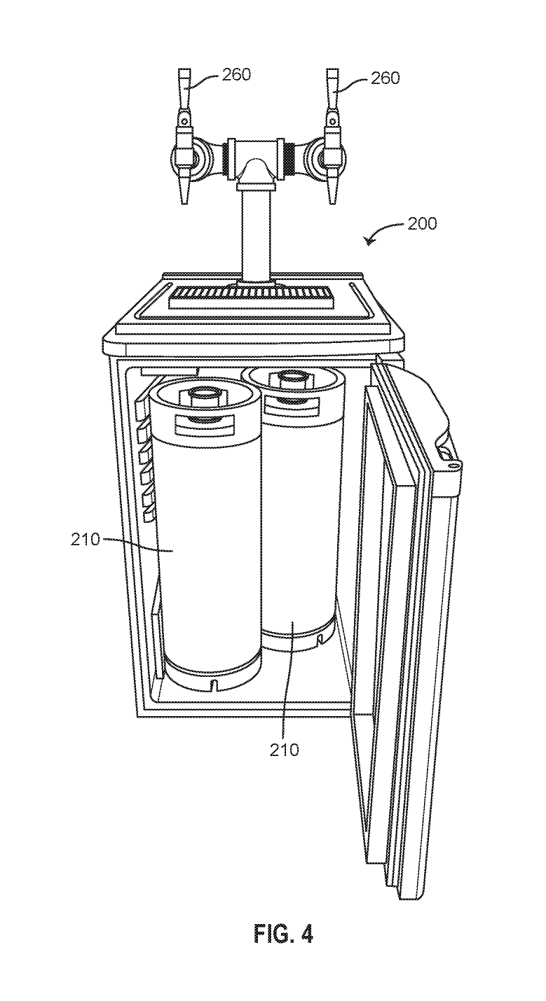

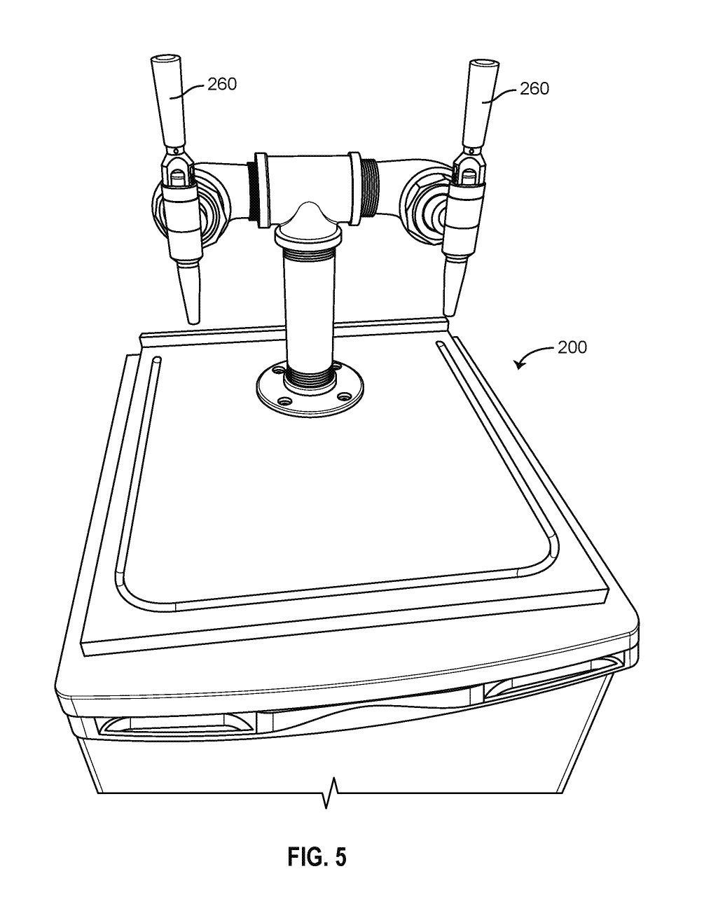

According to the exemplary embodiment of FIGS. 2-7, a system, shown as beverage dispensing system 200, is shown. Beverage dispensing system 200 includes a reservoir, shown as storage vessel 210 (e.g., keg, chamber, tank, bottle, vessel, etc.). While installed in beverage dispensing system 200, storage vessel 210 is configured to hold brewed and nitrogenated coffee such as coffee brewed from brewing process 100. In some applications, storage vessel 210 is refrigerated and/or insulated. Beverage dispensing system 200 also includes a meter, shown as flow meter 220, coupled to storage vessel 210 and configured to detect the brewed and nitrogenated coffee flowing from storage vessel 210. Flow meter 220 is configured to obtain flow information (e.g., data, measurements, characteristics, etc.) of the brewed and nitrogenated coffee flowing from storage vessel 210.

Beverage dispensing system 200 also includes a valve, shown as valve 230, and a heater (e.g., heating element, etc.), shown as heater 240, coupled to flow meter 220 and configured to receive the brewed and nitrogenated coffee from flow meter 220. Valve 230 is configured to be operable between an open position, where the brewed and nitrogenated coffee passes through valve 230, and a second closed position, where the brewed and nitrogenated coffee is prevented from passage through valve 230. Heater 240 is operable between an on state where heater 240 is configured to heat the brewed and nitrogenated coffee passing through heater 240 to a target temperature, and an off state where heater 240 does not heat the brewed and nitrogenated coffee passing through heater 240.

Due to the nitrogen in the brewed and nitrogenated coffee, a foam head in the brewed and nitrogenated coffee is formed. Because the composition of the Earth's atmosphere contains approximately seventy-eight percent nitrogen, the nitrogen in the brewed and nitrogenated coffee tends to stay in the foam head. Advantageously, the foam head of the brewed and nitrogenated coffee is larger than a foam head of a typical coffee, resulting in a more desirable coffee. In some applications, the foam head of the heated, brewed and nitrogenated coffee may be maintained for at least five to ten minutes.

Beverage dispensing system 200 also includes a flow restrictor, shown as flow restrictor 250, coupled to heater 240 and configured to regulate the flow of the brewed and nitrogenated coffee from heater 240. Flow restrictor 250 limits the flow (i.e., decreases the flow rate) of the brewed and nitrogenated coffee flowing through heater 240. Beverage dispensing system 200 also includes a faucet, shown as faucet 260 (e.g., stout faucet, etc.), coupled to valve 230 and flow restrictor 250 and configured to receive the brewed and nitrogenated coffee from valve 230 and the brewed and nitrogenated coffee from flow restrictor 250. Faucet 260 is operable by an operator to dispense the liquid into a receptacle (e.g., cup, mug, glass, container, bottle, can, etc.).

Beverage dispensing system 200 also includes a processing circuit, shown as processing circuit 270. Processing circuit 270 includes a processor, shown as processor 272, and a memory, shown as memory 274. Processing circuit 270 is electronically communicable with (e.g., electronically coupled to, etc.) flow meter 220, valve 230, heater 240, and a switch, shown as control switch 280 to receive input from an operator. Control switch 280 is configured to communicate with processing circuit 270 to control valve 230 and/or heater 204. For example, the operator may interface with control switch 280 to articulate valve 230 from the open position to the closed position. Following this example, control switch 280 may be in a first position causing valve 230 to be in the open position and heater 240 to be in the off state. According to this example, when control switch 280 is in the first position, cold brewed and nitrogenated coffee may be dispensed. In this example, control switch 280 may also be in a second position causing valve 230 to be in the closed position and heater 240 to be in the on state. According to this example, when control switch 280 is in the second position, hot brewed and nitrogenated coffee may be dispensed. In this example, heater 240 receives all of the flow of brewed and nitrogenated coffee.

Processing circuit 270 is configured to relay information between control switch 280 and flow meter 220, valve 230, and heater 240. Flow meter 220 is configured to provide information (e.g., data, measurements, characteristics, etc.) related to the flow of the brewed and nitrogenated coffee flowing from storage vessel 210 to processing circuit 270. For example, flow meter 220 may provide a flow rate (e.g., mass flow rate, etc.) of the liquid flowing from storage vessel 210 to processing circuit 270.

In some applications, beverage dispensing system 200 may be configured hold more than one storage vessel 210. For example, beverage dispensing system 200 may be configured to hold two or more storage vessels 210. According to this example, the two or more brew vessels 210 may be interconnected such that beverage dispensing system 200 need only be connected to one of the two or more brew vessels 210 to receive brewed and nitrogenated coffee from the two or more brew vessels 210. Beverage dispensing system 200 may be configured to refrigerate and/or insulate storage vessel 210. Storage vessel 210 may also be insulated independent from beverage dispensing system 200. For example, storage vessel 210 may be vacuum insulated. In an alternative embodiment, processing circuit 270 is configured to be electronically communicable with storage vessel 210 to determine an amount of brewed and nitrogenated coffee remaining in storage vessel 210.

Storage vessel 210 includes a coupler for coupling storage vessel 210 to flow meter 220. According to various embodiments, the coupler is a Sankey coupler. However other couplers, such as Cornelius couplers, may also be used. In various embodiments, storage vessel 210 is configured to be nitrogenated prior to being inserted in beverage dispensing system 200. However, in an alternative embodiment, storage vessel 210 may be nitrogenated after being inserted in beverage dispensing system 200 but before being coupled to flow meter 220. Because of the relatively high pressure of nitrogen in the brew vessel after nitrogenation (e.g., the target dispensing system pressure) the nitrogen will come out of the brewed and nitrogenated coffee easily when poured and will remain largely entrained in a foam head.

In various applications, flow meter 220 is one of an infrared flow meter, a mechanical flow meter, a pressure-based meter, an optical flow meter, an open-channel flow meter, a thermal mass flow meter, a vortex flow meter, and electromagnetic flow meter, an ultrasonic flow meter, a Coriolis flow meter, and a laser Doppler flow meter. According to an exemplary embodiment, flow meter 220 is an infrared flow meter. Flow meter 220 may record a volume of the brewed and nitrogenated coffee passing through flow meter 220. For example, in one embodiment, flow meter 220 is a Swissflow® infrared flow meter. Alternatively, flow meter 220 is Nutating disc flow meter. In an alternative embodiment, flow meter 220 is a rotameter. In various applications, valve 230 is an electronically controllable solenoid valve. However, valve 230 may be a ball valve, a gate, valve, a globe valve, a check valve, a butterfly valve, a safety valve, a plug valve, or any other suitable valve such that beverage dispensing system 200 is tailored for a target application.

Heater 240 may be defined by a target temperature of the brewed and nitrogenated coffee. In other applications, heater 240 may be defined by a temperature that heater 240 must attain. In various embodiments, heater 240 has a target temperature of between sixty degrees Celsius (e.g., one-hundred and forty degrees Fahrenheit) and approximately 71.1 degrees Celsius (e.g., one-hundred and sixty degrees Fahrenheit). According to an exemplary embodiment, heater 240 has a target temperature of approximately 71.1 degrees Celsius (e.g., one-hundred and sixty degrees Fahrenheit). In some applications, the target temperature of heater 240 is variable and/or set to follow a specific pattern or curve.

According to various embodiments, heater 240 is a heat exchanger. For example, heater 240 may be a tubular heat exchanger, a shell and tube heat exchanger, a microchannel heat exchanger, a spiral heat exchanger, or any other suitable heat exchanger such that beverage dispensing system 200 is tailored for a target application. The heat exchangers are configured to transfer heat from a hot fluid to the brewed and nitrogenated coffee. According to these embodiments, heater 240 may be turned off such that heating of the fluid flowing therethrough is ceased. Alternatively, heater 240 may be a heating element (e.g., metal heating element, ceramic heating element, polymer heating element, composite heating element, etc.) or a combination thereof. In another alternative embodiment, heater 240 is a waste heat recovery unit that recovers heat from a hot gas stream near beverage dispensing system 200. For example, heater 240 may recover waste heat from the exhaust of an engine or from the vent of a stove or oven. Heater 240 may also utilize heated fluid from a solar water heater or water heater. Heater 240 may also be a condenser of a refrigeration circuit. For example, storage vessel 210 may be cooled by a refrigeration circuit that includes a condenser configured to be heater 240. Alternatively, the condenser in such a refrigeration circuit may heat a fluid which is routed to heater 240.

Flow restrictor 250 may be defined by an amount of flow that exits flow restrictor 250 to faucet 260 in a target amount of time (e.g., liters per minute, gallons per minute, etc.). Flow restrictor 250 may be chosen such that the brewed and nitrogenated coffee is present within heater 240 for a target amount of time in order to facilitate a desired increase in temperature of the brewed and nitrogenated coffee in heater 240. In one embodiment, flow restrictor 250 is chosen such that the brewed and nitrogenated coffee achieves the target temperature in heater 240 (e.g., between sixty degrees Celsius (e.g., one-hundred and forty degrees Fahrenheit) and approximately 71.1 degrees Celsius (e.g., one-hundred and sixty degrees Fahrenheit), etc.). Accordingly, flow restrictor 250 is placed downstream of heater 240. However, beverage dispensing system 200 may include other flow restrictors in other locations in addition to flow restrictor 250. In some applications, a flow restrictor 250 is a variable flow restrictor. In other applications, flow restrictor 250 is replaced by a valve similar to valve 230. In those applications, the valve replacing flow restrictor 250 may be electrically coupled to processing circuit 270.

Depending on the target application, beverage dispensing system 200 may have any number of faucets 260. For example, in one embodiment, beverage dispensing system 200 has two faucets 260, such as one corresponding to a light coffee and one corresponding to a dark coffee. However, following this embodiment, beverage dispensing system 200 may include a third faucet 260 for a mixture of the light coffee and the dark coffee. The third faucet 260 may correspond to a set and determined mixture of the light coffee and the dark coffee or may be adjustable so as to alter the ratio of light coffee to dark coffee as desired by the operator. Each faucet 260 may be independently coupled to storage vessel 210. For example, in the case where beverage dispensing system 200 includes one faucet 260 for light coffee and one faucet 260 for dark coffee, the faucet 260 for the light coffee may be coupled to a first storage vessel 210 and the second faucet 260 may be coupled to a second storage vessel 210.

According to various embodiments, processing circuit 270 communicates with various components (e.g., flow meter 220, valve 230, heater 240, flow restrictor 250, etc.) of beverage dispensing system 200 via wired communications. However, in some alternative embodiments, processing circuit 270 leverages wireless communications technologies such as near field communications, Wi-Fi, Bluetooth®, cellular networks, and other wireless communications technologies to communicate with various components (e.g., flow meter 220, valve 230, heater 240, flow restrictor 250, etc.) of beverage dispensing system 200 such that beverage dispensing system 200 is tailored for a target application. Various components (e.g., flow meter 220, valve 230, heater 240, flow restrictor 250, etc.) of beverage dispensing system 200 may communicate such that operation of one of the various components may influence operation of another of the various components.

Similarly, processing circuit 270 may utilize wireless communications technologies to communicate with external mobile devices such as smart phones, tablets, computers, smart devices (e.g., watches, eye ware, bracelets, etc.), laptops, and other mobile devices such that beverage dispensing system 200 is tailored for a target application. For example, beverage dispensing system 200 may leverage wireless communications technologies to receive an order at processing circuit 270 from a customer's external mobile device through a mobile application. If an order is received by processing circuit 270 from a mobile application, processing circuit 270 may transmit an order confirmation back to the external mobile device of the customer. The order confirmation may include a location of beverage dispensing system 200 and an estimated order completion time. Similarly, processing circuit 270 may transmit an alert to the customer indicating that the order is ready for pick up at beverage dispensing system 200. The customer may also utilize the mobile application to visualize a location of beverage dispensing system 200 (e.g., on a map, etc.). In some embodiments, beverage dispensing system 200 is communicable with a computer external to beverage dispensing system 200 such that the operator can monitor and interact with beverage dispensing system 200 remotely. For example, the operator may use the computer external to beverage dispensing system 200 to turn on and off heater 240. In another example, the operator may use the computer external to beverage dispensing system 200 to monitor the capacity (e.g., the remaining brewed and nitrogenated coffee, etc.) of storage vessel 210.

The mobile application may be accessed through the use of an external mobile device. According to various embodiments, the mobile application provides a location of the customer to beverage dispensing system 200 such that an order may be delivered to a customer's location. The mobile application may allow the customer to place an order, check on the status of an existing order, view order history, access news and social media posts related to beverage dispensing system 200, and other actions related to beverage dispensing system 200. In some embodiments, the mobile application displays a location of beverage dispensing system 200 on a map, such that the customer can easily locate beverage dispensing system 200. The mobile application may allow the customer to communicate with other friends regarding the location of beverage dispensing system 200 (e.g., on social media). The mobile application may store customer preferences for an order, such as details of a most recent order, thereby simplifying the ordering process for the customer.

In some circumstances, the customer may utilize the mobile application to purchase a coffee for a different customer. In this case, the processing circuit receives the order and alerts the second customer that a gift has been made through a notification displayed on a display of a second external mobile device (e.g., “JOHN DOE HAS GIVEN YOU A COFFEE! SAY THANK YOU!” etc.). Alternatively, the second customer receives a notification on a display of an external mobile device of the second customer indicating that an order has been placed. This indication may include a location of beverage dispensing system 200, an option to redeem the coffee at a later date, an option to send a personalized message to the customer who purchased the coffee, and an option to purchase a coffee for the customer who purchased the coffee for the second customer. If the personalized message is selected, the customer may receive a notification on a display of an external mobile device including the personalized message. In other words, the notification activates the screen on the second external mobile display in order to display the notification. This notification may also include the location of beverage dispensing system 200.

Information from use of the mobile application by customers may be available to the operator. For example, the mobile application may inform the operator of beverage dispensing system 200 where customers are concentrated on a map, or the location of customers who have placed orders. Similarly, the mobile application may store historical data for the operator such that the operator can predict where past and/or potential customers may be depending on various factors such as the day, the time, the weather, local events, and social media posts. In some alternative examples, the mobile application can plan a suggested route for the operator, based on the aforementioned information, to follow to maximize interaction with the past and/or potential customers.

In some applications, control switch 280 includes a number of toggle switches, knobs, dials, levers, or other suitable switches such that beverage dispensing system 200 is tailored for a target application. Control switch 280 is operable between a first position and a second position. Control switch 280 may be a single switch or may be multiple switches. Control switch 280 may be an interactive touch screen configured to digitally display the switches and to display real time information related to the various components (e.g., flow meter 220, valve 230, heater 240, flow restrictor 250, etc.) of beverage dispensing system 200. In an alternative embodiment, control switch 280 is built into a handle of faucet 260. For example, articulation of the handle in one direction (e.g., backward) may dispense brewed and nitrogenated coffee from faucet 260 while the heater is off while articulation in another direction (e.g., forward) may dispense brewed and nitrogenated coffee from faucet 260 while the heater is on.

According to various embodiments, control switch 280 is structurally coupled to (e.g., attached to, etc.) beverage dispensing system 200. In an alternative embodiment, processing circuit 270 is configured to communicate with an external mobile device belonging to the operator of beverage dispensing system 200 and to access a mobile application for beverage dispensing system 200. Following this alternative embodiment, the operator of beverage dispensing system 200 can interface with the various components (e.g., flow meter 220, valve 230, heater 240, flow restrictor 250, etc.) of beverage dispensing system 200 through the mobile application on the external mobile device. Similarly, the operator can leverage the mobile application to remotely monitor metrics of beverage dispensing system 200. The metrics may include a measurement of how much brewed and nitrogenated coffee is remaining in the brew vessel and/or a capacity of storage vessel 210. The measurement of how much brewed and nitrogenated coffee is remaining in the brew vessel may be calculated by comparing flow measurements from flow meter 220 to the capacity of storage vessel 210. The capacity of storage vessel 210 may be a constant quantity, known to processing circuit 270. In some circumstances, processing circuit 270 computes a suggested route for beverage dispensing system 200 to travel. The suggested route may be chosen based on current orders from customers, order history from customers (i.e., which areas have had high sales, etc.), nearby events (e.g., sporting events, etc.), and social media posts.

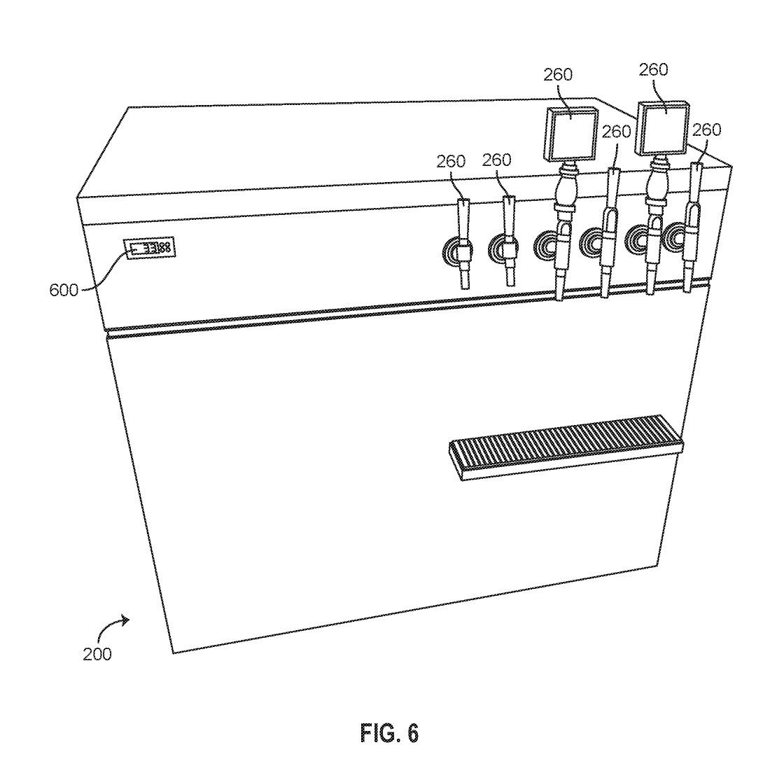

As shown in FIG. 6, beverage dispensing system 200 includes a display, shown as display panel 600. Display panel 600 may include interactive buttons that facilitate interaction of the operator with beverage dispensing system 200 (e.g., buttons to change the target temperature of heater 240, etc.). Display panel 600 may be electronically communicable with processing circuit 270. Similar displays may also be incorporated in other manners on beverage dispensing system 200. For example, beverage dispensing system 200 may include a touch screen display that may be utilized by a customer for order placement. Similarly, beverage dispensing system 200 may include display screens that are configured to display advertisement material. Beverage dispensing system 200 may further include display screens to indicate when a target customer's order is ready.

Beverage dispensing system 200 is configured to be powered by either alternating current (AC) electrical power or direct current (DC) electrical power. In one embodiment, beverage dispensing system 200 is electrically coupled to an AC wall socket configured to provide a standard voltage (e.g., 120 volts, 220 volts, 230 volts, etc.). In another embodiment, beverage dispensing system 200 is electrically coupled to a battery. The battery may be electrically coupled to an electrical power generation mechanism such as a solar panel array or a fuel cell. Similarly, beverage dispensing system 200 may utilize electrical power from multiple sources simultaneously. For example, beverage dispensing system 200 may utilize a propane source for heater 240 while utilizing a battery for flow meter 220, valve 230, processing circuit 270, and control switch 280.

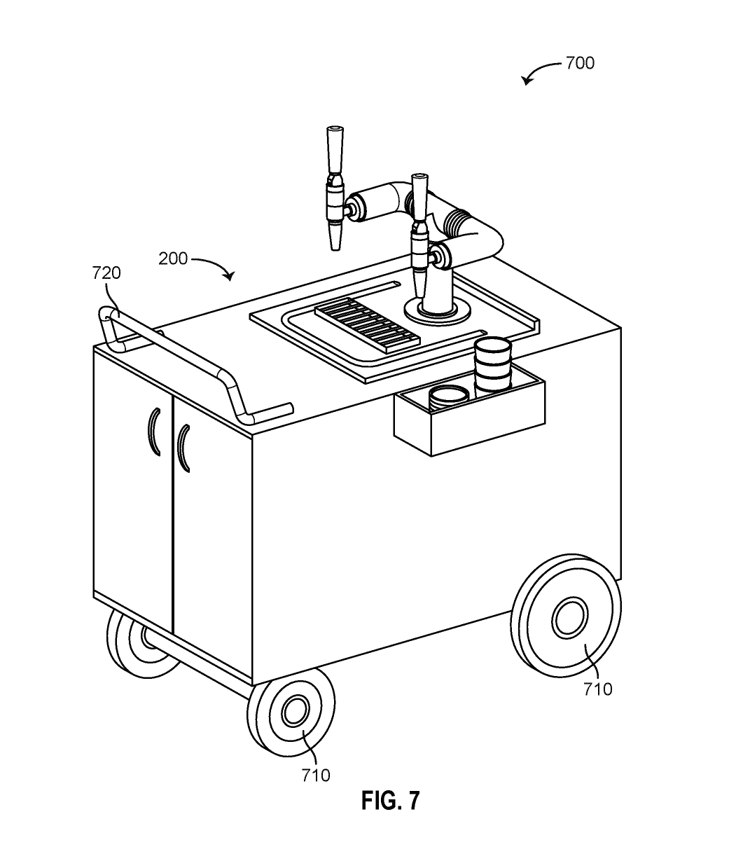

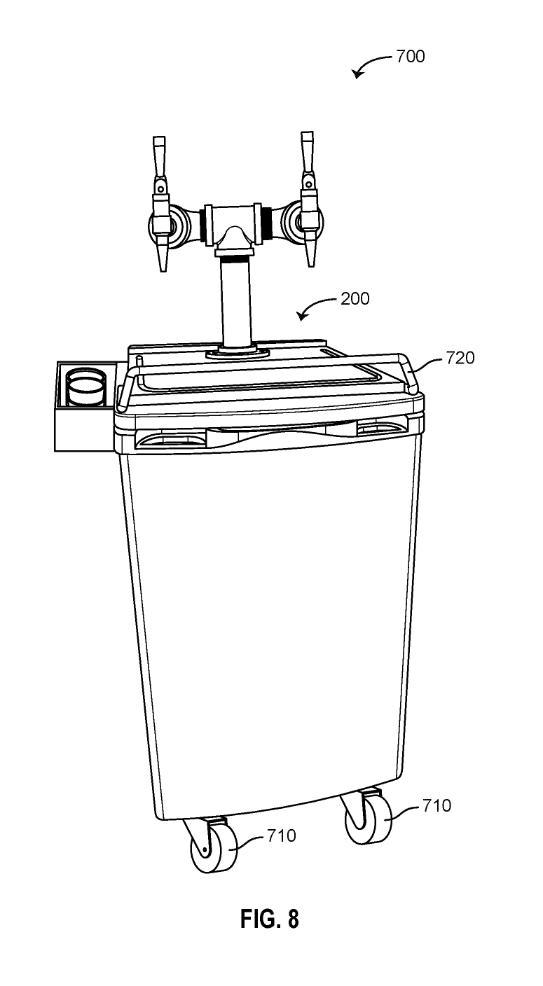

As shown in FIGS. 7 and 8, a system, shown as mobile delivery system 700, includes beverage dispensing system 200 along with a plurality of wheels, shown as wheels 710, and a handle, shown as handle 720. An operator of mobile delivery system 700 may interact with (e.g., push) handle 720 such that mobile delivery system 700 moves beverage dispensing system 200 along a path via wheels 710. According to various embodiments, mobile delivery system 700 is used to deliver brewed and nitrogenated coffee to customers at locations remote from a conventional (e.g., brick and mortar, etc.) storefront. For example, mobile delivery system 700 may be utilized by an operator to deliver brewed and nitrogenated coffee at a beach, park, festival, convention, sporting event, or other event. Mobile delivery system 700 may be used to both deliver orders and to prepare brewed and nitrogenated coffee for new orders using beverage dispensing system 200. According to one embodiment, mobile delivery system 700 facilitates customer selection between at least two different types of brewed and nitrogenated coffee from beverage dispensing system 200. In one example, mobile delivery system 700 facilitates a customer selection between a light brewed and nitrogenated coffee and a dark brewed and nitrogenated coffee.

Mobile delivery system 700 can be configured to be tailored to a target application. Mobile delivery cart may be a hand cart, a dolly, a vendor cart, a food services cart, a hot dog cart, an ice cream cart, or any other suitable cart structure. Mobile delivery system 700 may include heater 240 mounted on the back of beverage dispensing system 200, underneath handle 720. Similarly, various devices and objects may also be coupled to mobile delivery system. For example, a storage unit for receptacles (e.g., cups, etc.), an umbrella, speakers, and other devices and objects may be coupled to mobile delivery system 700. In one embodiment, beverage dispensing system 200 includes an access panel (e.g., door) underneath handle 720 such that the operator can interact with storage vessel 210 without moving away from handle 720. According to one embodiment, mobile delivery system 700 includes four wheels. However, more or less wheels 710 may be included. For example, mobile delivery system may include two wheels on one end and two rests on another end. Following this example, the operator may move mobile delivery system 700 by lifting off of the rests and using the two wheels 710.

Even though brewing process 100, beverage dispensing system 200, and mobile delivery system 700 have been shown and described relative to brewed and nitrogenated coffee, it is understood that brewing process 100 and beverage dispensing system 200 may similarly be used with other types of beverages. According to various embodiments, the liquid dispensed by beverage dispensing system 200 is a hot or cold beverage. For example, beverage dispensing system 200 may dispense hot or cold (e.g., “iced,” etc.) coffee, tea, milk, hot cocoa, hot chocolate, espresso, cider, asiatico, eggnog, water, lemonade, sake, soda, punch, or any other suitable beverage such that beverage dispensing system 200 may be tailored for a target application. Similarly, brewing process 100 may be adapted to produce various hot or cold (e.g., “iced,” etc.) beverages such as coffee, tea, milk, hot cocoa, hot chocolate, espresso, cider, asiatico, eggnog, water, lemonade, sake, soda, punch, or any other suitable beverage. Depending on the beverage, more or less steps than those illustrated by brewing process 100 may be necessary. The following example illustrates an implementation of brewing process 100 to produce hot cocoa where the hot cocoa is nitrogenated at 310.3 kPa (45 PSI).

| | | |
|---|---|---|
| Amount of Cocoa Beans [kilograms (pounds)] | 0.34 | (0.75) |
| Amount of water [liters (gallons)] | 5.7 | (1.5) |
| Amount of nitrogen [cubic meters (cubic feet)] | 0.02 | (0.7) |
| Amount of water added in step 120 [liters | 3.8 | (1) |
| (gallons)] | | |

| | |
|---|---|
| Target steeping pressure in step 130 [kPa | 0 |
| (PSI)] (gauge) | |
| Duration of steeping time in step 130 [hours] | 0.33 |
| Chill time in step 140 [hours] | 0.17 |
| Filter pressure in step 170 [kPa (PSI)] (gauge) | 0 |
| Amount of water used to rinse filter in step 172 | 0 |
| [liters (gallons)] | |

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the multi-section refuse ejector as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed:

1. A system for dispensing a beverage, the system comprising:
a storage vessel configured to store the beverage;
a flow meter fluidly coupled to the storage vessel and configured obtain flow measurements of the beverage from the storage vessel;
a first fluid path comprising a valve fluidly coupled to the flow meter and to a faucet; and
a second fluid path comprising a heater fluidly coupled to the flow meter and to a flow restrictor;
wherein the heater is operable between a first state and a second state;
wherein the heater is configured to increase a temperature of the beverage passing through the heater to a target temperature when the heater is in the first state.

2. The system of claim 1, further comprising:
a processing circuit electronically communicable with the flow meter, the valve, the heater, and a control switch configured to receive input from an operator;
wherein the control switch is operable between a first position and a second position;
wherein the valve is operable between an open position where flow of beverage through the valve is not impeded and a closed position where flow of beverage is at least partially impeded;
wherein the control switch causes the valve to be in the open position and the heater to be in the second state when the control switch is in the first position; and
wherein the control switch causes the valve to be in the closed position and the heater to be in the first state when the control switch is in the second position.

3. The system of claim 1, wherein the beverage in the storage vessel is nitrogenated.

4. The system of claim 3, wherein the faucet is a stout faucet configured to agitate nitrogen in the beverage;
wherein the storage vessel is refrigerated; and
wherein the flow restrictor is selected to allow the beverage to encounter the heater for a target amount of time based on a flow rate of the flow restrictor.

5. The system of claim 1, wherein the beverage is coffee.

6. The system of claim 1, further comprising:
a handle configured to receive input from an operator to move the system for dispensing the beverage; and
a plurality of wheels configured to facilitate movement of the system for dispensing the beverage;
wherein the processing circuit is configured to receive an order from an external mobile device of a customer through an application; and
wherein the customer can visualize a location of the system for dispensing coffee on a display of the external mobile device through the application.

7. The system of claim 6, wherein the operator is capable of remotely monitoring metrics of the system for dispensing the beverage through the use of a second application on a second external device;
wherein the metrics include a measurement of how much beverage is remaining in the storage vessel; and
wherein the amount of beverage remaining in the storage vessel is calculated based on a comparison of the flow measurements from the flow meter to a capacity of the storage vessel.

8. The system of claim 7, wherein the metrics further include a suggested route for the system for dispensing the beverage to travel; and
wherein the suggested route is based on at least one of current orders, past orders, nearby events, and social media posts.

9. The system of claim 1, wherein the target temperature is between fifty-five degrees Celsius and seventy-five degrees Celsius.

10. A method of providing a nitrogenated liquid, the method comprising:
pressurizing a vessel with nitrogen at a target steeping pressure;
steeping the vessel for a steeping time at a first temperature;
decreasing a temperature of the vessel to a chilled steeping temperature lower than the first temperature;
steeping at the second temperature;
rapidly decreasing a pressure of the vessel in such a manner as to cause nitrogen cavitation within the vessel, thereby producing a brew fluid.

11. The method of claim 10, further comprising:
directing brew fluid from the vessel through a filter in the filter unit at a filter pressure and into a storage vessel;
placing the storage vessel in a beverage dispensing system; and
nitrogenating the storage vessel by pressurizing the storage vessel with a target dispensing system pressure resulting in a brewed and nitrogenated liquid.

12. The method of claim 11, further comprising:
refrigerating the storage vessel; and
heating the brewed and nitrogenated liquid after the liquid leaves the storage vessel but prior to the brewed and nitrogenated liquid being dispensed.

13. The method of claim 10, wherein the target steeping pressure is between one-hundred and eighty-five kilopascals and three-hundred and fifteen kilopascals;
wherein the steeping time is between seven hours and fifteen hours;
wherein the first temperature is room temperature; and
wherein the filter pressure is between thirty kilopascals and one-hundred kilopascals.

14. The method of claim 12, further comprising:
receiving, by the beverage dispensing system, an order for the liquid from a customer through a mobile application accessed via an external mobile device; and
transmitting, by the beverage dispensing system, an order confirmation including a location of the beverage dispensing system and an estimated order completion time.

15. The method of claim 14, further comprising:
transmitting, by the beverage dispensing system, an alert to the customer indicating that the order is ready for pick up at the beverage dispensing system.

16. The method of 10, further comprising:
accessing, by an operator of the beverage dispensing system, metrics associated with the operation of the beverage dispensing system;
wherein the metrics include a capacity of the vessel.

17. The method of claim 10, wherein the nitrogenated liquid is coffee.

18. A mobile delivery system for delivering hot, nitrogenated coffee to a customer, the mobile delivery system comprising:
an application accessible by a customer using an external mobile device; and
a beverage dispensing system comprising:
a storage vessel configured to store brewed and nitrogenated coffee;
a flow meter fluidically coupled to the storage vessel and configured to measure flow of the brewed and nitrogenated coffee from the storage vessel;
a valve fluidically coupled to the flow meter and to a faucet;
a heater fluidically coupled to the flow meter and to a flow restrictor; and
a processing circuit configured to be communicable with the application;
wherein the customer may place an order for a coffee at the beverage dispensing system using the application; and
wherein the processing circuit is configured to receive the order and transmit an order confirmation to the customer, the order confirmation including a location of the mobile delivery system and an expected order completion time.

19. The system of claim 17, wherein the heater is operable between a first state and a second state;
wherein the heater is configured to increase a temperature of the brewed and nitrogenated coffee passing through the heater when the heater is in the first state; and
wherein the heater is not configured to increase a temperature of the brewed and nitrogenated coffee passing through the heater when the heater is in the second state.

20. The system of claim 18, wherein the customer can visualize a location of the mobile delivery system on a display of the external mobile device through the application;
wherein the customer can order a coffee for a second customer through the application;
wherein the processing circuit is configured to alert the second customer that a gift has been made through a notification displayed on a display of a second external mobile device; and
wherein the notification includes the location of the mobile delivery system.

21. The system of claim 18, further comprising a control switch configured to receive input from an operator;
wherein the control switch is operable between a first position and a second position;
wherein the valve is operable between an open position where flow of brewed and nitrogenated coffee through the valve is not impeded and a closed position where flow of the brewed and nitrogenated coffee is at least partially impeded;
wherein the control switch causes the valve to be in the open position and the heater to be in the second state when the control switch is in the first position; and
wherein the control switch causes the valve to be in the closed position and the heater to be in the first state when the control switch is in the second position.

22. The system of claim 18, further comprising a second application configured to be accessed by an operator of the mobile delivery system on a second mobile electronic device;
wherein the second application facilitates remote monitoring of metrics of the mobile delivery system;
wherein the metrics include a measurement of how much brewed and nitrogenated coffee is remaining in the storage vessel.

23. The system of claim 22, wherein the amount of brewed and nitrogenated coffee remaining in the storage vessel is calculated based on a comparison of flow measurements obtained from the flow meter to a capacity of the storage vessel.

24. A method of providing a hot, brewed beverage, comprising:
brewing a beverage at a first temperature, wherein the first temperature is at or below room temperature;
nitrogenating a storage vessel containing the beverage by pressurizing the vessel, resulting in a brewed and nitrogenated liquid;
directing the brewed and nitrogenated liquid past a heating element to rapidly heat the beverage to a second temperature, higher than the first temperature; and
dispensing the fluid directly after heating the beverage with the heating element.
